(19) United States
(12) Patent Application Publication
(10) Pub. No.: US 2004/0093756 A1
(43) Pub. Date: May 20, 2004

(54) Filter device for a hair dryer

(75) Inventors: Vito James Carlucci, Stratford, CT (US); Henri Christophe Frederic Joseph Smal, Vise (BE)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: CONAIR CIP, INC.

(21) Appl. No.: 10/294,815

(22) Filed: Nov. 14, 2002

(51) Int. Cl. F26B 21/06

(52) U.S. Cl. 34/82; 34/96; 34/97; 55/385.1; 392/385

(57) ABSTRACT

There is provided a filter for use with a hair air-styling device and a method for maintaining and/or replacing such a filter. The filter has a frame for detachably retaining a flexible screening fabric so as to form an air permeable wall. The filter is telescopically connected to the hair air-styling device so as to provide a user selective access to the filter, thereby enabling the user to quickly visually ascertain the condition of the filter, and, if needed, to easily clean and/or remove and replace the filter.

### BACKGROUND OF THE INVENTION

1. Field of the Invention

The present invention relates to a filter device for use with a hair air-styling device.

2. Description of the Prior Art

Filters for hair air-styling devices, such as a hair dryer, operate to inhibit undesired air born contaminants from entering into the hair air-styling device to prevent soiling of and damage to the hair air-styling device. Typically these filters use a fabric mat of the type that requires at least periodic cleaning maintenance or replacement. It is commonly known that failure to provide such maintenance can result in excessive thermal loading to the hair air-styling, which in turn can damage such a device. As users often delay or neglect entirely making the necessary maintenance of the filters, it is advantageous to provide a filter that is conveniently and easily maintained and/or replaced.

### SUMMARY OF THE INVENTION

It is an object of the present invention to provide a filter for use with a hair air-styling device that makes maintenance and/or replacement thereof convenient and relatively effortless for the user to complete.

It is another object of the present invention to provide a filter that is telescopically connected with the hair air-styling device.

It is still another object of the present invention to provide a filter that can employ a variety of different types of screening fabric.

It is yet another object of the present invention to provide a filter that enables a user to visually ascertain when the filter needs maintenance.

It is yet still another object of the invention to provide a filter that improves filtering efficiency via electrostatics.

These and other objects and advantages of the present invention are achieved by a filter having a flexible screening fabric and a frame for detachably retaining the flexible screening fabric. The frame is telescopically connected to a hair air-styling device.

### BRIEF DESCRIPTION OF THE DRAWINGS

The present invention is more fully understood by reference to the following detailed description of an illustrative embodiment in combination with the drawings identified below.

FIG. 1 is a perspective view of a filter in accordance with an illustrative embodiment of the present invention;

FIG. 2 is a first end view of the filter of FIG. 1;

FIG. 3 is a side view of the filter of FIG. 1; and

FIG. 4 is an exploded view of an illustrative hair air-styling device incorporating the filter of FIG. 1.

### DETAILED DESCRIPTION OF THE INVENTION

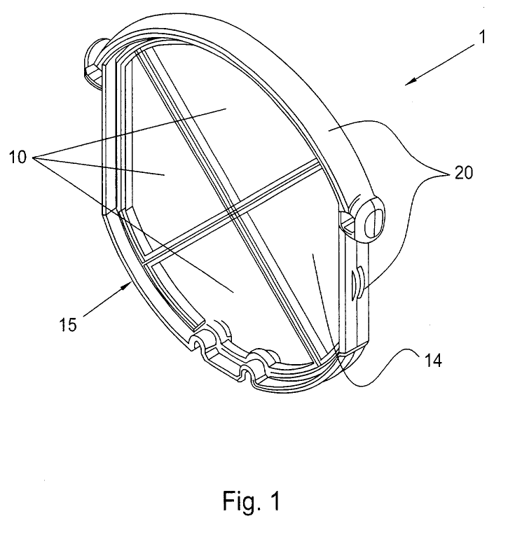

Referring to the drawings and, in particular, FIG. 1, there is shown an illustrative embodiment of an improved filter 1 for use with a hair air-styling device 5 having a flexible screening fabric 10 and a frame 15 for retaining flexible screening fabric 10.

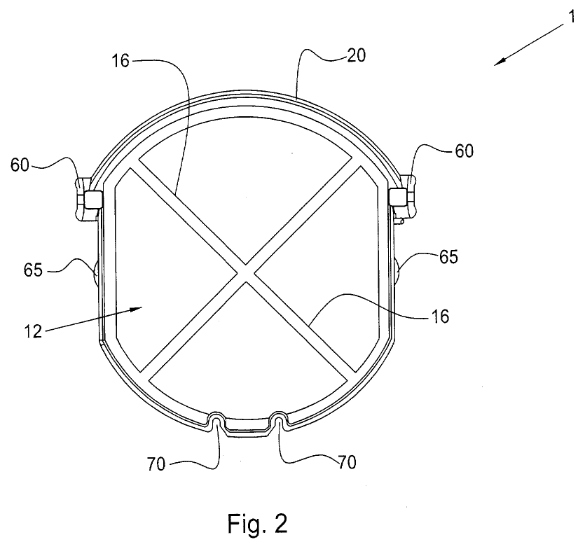

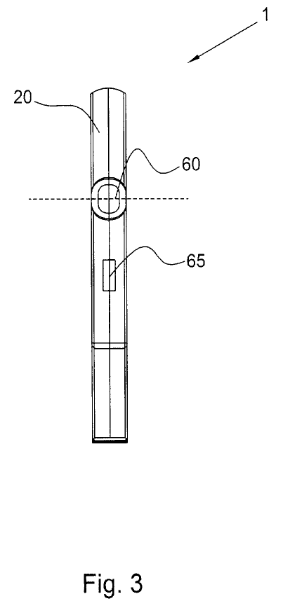

Referring to FIGS. 1 through 3, flexible screening fabric 10 can preferably be placed or retained on frame 15 such that fabric 10 creates an air permeable wall 14. Fabric 10 is preferably removably retained on frame 15 using an adhesive, a connector, or any other suitable securing mechanism sufficient to provide flexibility in use and to allow the flexible screening fabric to be removed and/or replaced. Fabric 10 can also be permanently secured to or connected to frame 15.

It is noted that fabric 10 can be formed of any material sufficient to sift and strain various impurities and undesired contaminants from the air entering hair air-styling device 5. Some examples of suitable materials include: naturally porous materials, thermoplastic materials such as polyester, glass materials, and perforated foil or metal materials. Further, fabric 10 can preferably be electrically conductive and charged sufficiently so as to safely, yet effectively, attract and retain various impurities from the air, thereby enhancing the efficiency of the filtering effect. Still further, fabric 10 can preferably be colored to enable a user to readily visually ascertain when maintenance and/or replacement of the fabric is warranted.

Preferably, frame 15 is connected to hair air-styling device 5 so as to selectively prevent undesired air born pollutants or contaminants from being drawn into the hair air-styling device. It is noted that frame 15 can be selectively detachable from hair air-styling device to facilitate maintenance and/or replacement thereof. It is also noted that frame 15 can alternatively be permanently connected to said hair air-styling device to prevent removal and misplacement thereof. In addition, frame 15 can also be grounded to operate as a collector of electrostatically charged dust particles.

Frame 15 preferably has an outer rim 20 forming an inner space 12 over which flexible screening fabric 10 is stretched to form wall 14. It is noted that inner space 12 can be traversed by at least one rib 16 to support fabric 10 as it spans inner space 12. Also, inner space 12 may also be traversed by a grill (not shown) or like structure to provide, not only added support to fabric 10, but more surface area to which fabric 10 may adhere should fabric 10 be connected to frame 15 by an adhesive type connection. In addition, rib 16 can also be conductive and grounded or charged to function as a collector for electrostatically charged dust particles.

Frame 15 is preferably shaped to telescopically cooperate with hair air-styling device 5. This telescopic relationship preferably enables a user selective access to the filter. The selective access preferably allows the user to visually determine the condition of the filter. Further, the selective access preferably also enables a user, should fabric 10 require cleaning, to easily and efficiently remove any collected undesired particulate matter by wiping or brushing over the surface of the fabric with their hand or a suitable tool for such a purpose. Still further, the selective access enables the user, should the condition of the fabric warrant, to quickly remove and replace the fabric with relative ease.

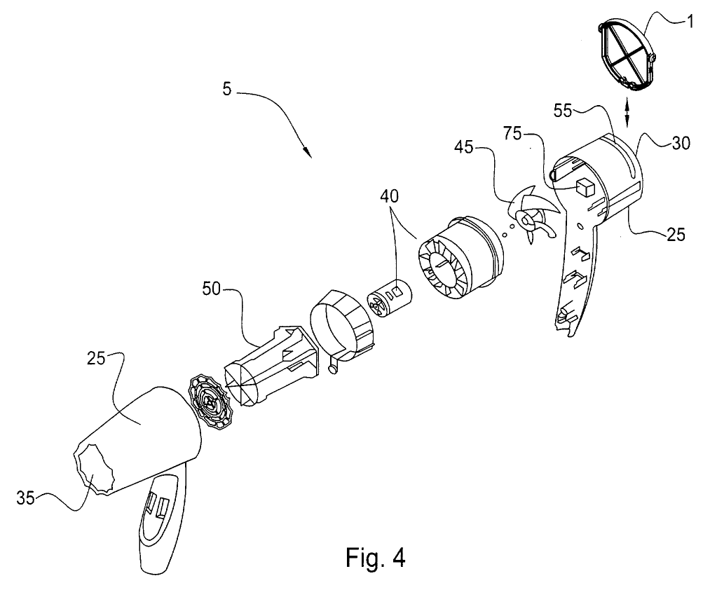

Referring to FIG. 4, preferably, hair air-styling device 5 has at least the following conventional elements: a housing 25 with an air inlet 30 and an air outlet 35, a power source (not shown), a motor assembly 40, a blower or fan 45, and a heating element 50. Hair air-styling device 5 can have any other feature foreseeably associated with such a device. In addition, hair air-styling device 5 has an opening 55 for telescopically receiving and retaining frame 15. Preferably, opening 55 is disposed adjacent air inlet 25. It is noted that frame 15 can have one or more projecting structures 60 that selectively abut housing 25, one or more friction bosses 65 that cooperate with opening 55, and one or more slots or grooves 70, all of which being configured to facilitate the sliding telescopic relationship between opening 55 of the hair air-styling device and frame 15 of the filter. It is also noted that frame 15 can be formed using from various materials and have any shape capable of telescopically cooperating with the hair air-styling device. Still further, it is noted that adjacent to air inlet 25, a high voltage source 75 for electrostatically charging the air and dust particles entering air-styling device 5 can be mounted upstream and/or downstream of the filter. High voltage source 75 can be a point source, such as a single needle or an array source, such as a plurality of needles, or a plurality of conductive fibers, or a system of charged metal plates or any similar configuration and/or combination thereof for ionizing and charging the air and air born particles with a static charge.

In use, filter 1 is advantageous in that it provides a filter for use with a hair air-styling device that makes maintenance and/or replacement thereof convenient and relatively effortless. Also, filter 1 is advantageous in that it can employ a variety of different types of screening fabric for providing different filtration effects. Further, filter 1 is advantageous in that it enables the user to visually ascertain when the filter needs maintenance.

The present invention having been thus described with particular reference to the preferred forms thereof, it will be obvious that various changes and modifications may be made therein without departing from the spirit and scope of the present invention as defined herein.

What is claimed is:

1. A filter for use with a hair air-styling device comprising:
a flexible screening fabric; and
a frame for retaining said flexible screening fabric, wherein said frame is telescopically connected to said hair air-styling device.

2. The filter of claim 1, wherein said flexible screening fabric is stretched across said frame to create an air permeable wall.

3. The filter of claim 1, wherein said flexible screening fabric is removably retained by said frame.

4. The filter of claim 1, wherein said flexible screening fabric is permanently retained by said frame.

5. The filter of claim 1, wherein said flexible fabric is held to said frame by an adhesive.

6. The filter of claim 1, wherein said flexible fabric is held to said frame by a connector.

7. The filter of claim 1, wherein said flexible screening fabric is formed of a thermoplastic material.

8. The filter of claim 1, wherein said flexible screening fabric is formed of a perforated foil material.

9. The filter of claim 1, wherein said flexible screening fabric is formed of an porous natural material.

10. The filter of claim 1, wherein said flexible screening fabric is formed of a glass material.

11. The filter of claim 1, wherein said flexible screening fabric is electrically conductive.

12. The filter of claim 11, wherein said flexible screening fabric is charged so as to attract and retain air impurities.

13. The filter of claim 1, wherein said flexible screening fabric is colored for visually indicating when maintenance and/or replacement of said flexible screening fabric are warranted.

14. The filter of claim 1, wherein said frame is releasably connected to said hair air-styling device.

15. The filter of claim 1, wherein said frame is permanently connected to said hair air-styling device.

16. The filter of claim 1, wherein said frame is connected adjacent an air inlet of said hair air-styling device so as to selectively prevent undesired air born contaminants from entering into said hair air-styling device.

17. The filter of claim 16, wherein said frame is grounded to operate as a collector of electrostatically charged particles.

18. The filter of claim 16, further comprising a high voltage ionizing source adjacent said filter to energize and/or charge particles to provide a more efficient filtering effect.

19. The filter of claim 1, wherein said frame has an outer rim forming an inner space.

20. The filter of claim 15, wherein said inner space is traversed by at least one rib.

21. The filter of claim 20, wherein said at least one rib is conductive and grounded to operate as a collector of electrostatically charged particles.

22. The filter of claim 15, wherein said outer rim is shaped to facilitate a telescopic relationship with said hair air-styling device.

23. The filter of claim 19, wherein said outer rim and said at least one rib provide support to said flexible screening fabric when said screening fabric is retained by said frame.

24. The filter of claim 15, wherein said inner space is traversed by a grill.

25. The filter of claim 22, wherein said outer rim and said grill provide support to said flexible screening fabric when said screening fabric is retained by said frame.

26. A method for maintaining and/or replacing a filter for use in an hair air-styling device comprising the steps of:
providing a flexible screening fabric and a frame for retaining said flexible screening fabric, wherein said frame has an outer rim forming an inner space and is telescopically connected adjacent an air inlet of said hair air-styling device so as to selectively prevent undesired air born contaminants from entering into said hair air-styling device;
securing said flexible screening fabric to said frame such that said flexible screening fabric is stretched across said inner space to create an air permeable wall and
telescopically inserting said filter in said hair air-styling device adjacent said air inlet;
depositing, during operation of said hair air-styling device, undesired particulate matter on said filter; and
telescopically removing said filter from in said hair air-styling device, thereby allowing a user access to said filter.

27. The method of claim 26, wherein the step of telescopically removing said filter allows said user too visually determine whether maintenance and/or replacement of said filter is warranted.

28. The method of claim 26, wherein the step of telescopically removing said filter allows said user to remove any undesired particulate matter collected on said filter.

29. The method of claim 26, wherein the step of telescopically removing said filter allows said user to remove and replace said screening fabric when necessary.
